(19) United States
(12) Patent Application Publication
(10) Pub. No.: US 2010/0306774 A1
(43) Pub. Date: Dec. 2, 2010

(54) Instant-On Computing System

(76) Inventor: Subash Kalbarga, Suwanee, GA (US)

Correspondence Address: HOPE BALDAUFF HARTMAN, LLC;Michael J. Baldauff, Jr., 1720 PEACHTREE STREET, N.W, SUITE 1010, ATLANTA, GA, 30309, US

(21) Appl. No.: 12/788,401

(22) Filed: May 27, 2010

Related U.S. Application Data
(60) Provisional application No. 61/181,850, filed on May 28, 2009.
(60) Provisional application No. 61/181,844, filed on May 28, 2009.

(51) Int. Cl. G06F 9/455; G06F 15/177; G06F 12/16

(52) U.S. Cl. 718/1; 713/2; 711/162; 711/E12.001; 711/E12.103

(57) ABSTRACT

A hypervisor loads a saved virtual machine image to provide an instant-on computing environment. A request may be received to switch from the instant-on computing environment to a native operating system. In response to such a request, the native operating system is executed and a hypervisor is executed on the native operating system. The saved virtual machine image is then loaded by the operating system based hypervisor to thereby provide the instant-on computing environment in conjunction with execution of the native operating system.

### CROSS-REFERENCE TO RELATED APPLICATIONS

This application claims the benefit of provisional U.S. patent application No. 61/181,850, filed on May 28, 2009, and entitled “Transition From an Instant-On Computing Environment,” and provisional U.S. patent application No. 61/181,844, filed on May 28, 2009, and entitled “Saved State Virtual Machine for Instant-On Computing System,” both of which are expressly incorporated herein by reference in their entirety.

### BACKGROUND

Computer users have long been frustrated by the amount of time it takes to boot their computer systems. One way that computer manufacturers have addressed this frustration is through instant-on operating environments that can be started more quickly than a full-blow operating system. Instant-on operating environments are typically feature limited operating systems that provide a subset of the functionality provided by the full-blown native operating systems typically executed by desktop and laptop computing systems. Previous implementations of instant-on environments, however, also suffer from a number of significant drawbacks.

It is with respect to these and other considerations that the disclosure presented herein has been made.

### SUMMARY

The following disclosure is directed to technologies for supporting an instant-on operating system (“OS”). As used herein, the term “instant-on OS” refers to an operating system that can be loaded more quickly than a full native operating system. As described briefly above, an instant-on OS might provide a more limited feature set as compared to a typical desktop operating system, such as a fixed selection of application programs. The term instant-on is not intended to imply that the operating system is loaded instantaneously.

According to embodiments presented herein, operation of an instant-on OS may be achieved by loading a hypervisor. Loading the hypervisor may include loading a thin OS, such as a thin LINUX OS, which in turn loads the hypervisor. The hypervisor may then load a saved virtual machine image. The saved virtual machine image may have been created in a pre-deployment phase. The saved virtual machine may be saved in a system read-only memory (“ROM”) or flash memory and thus not be easily changeable. The saved virtual machine may be a snapshot of a full installation of an OS. In contrast, some rapid boot systems only support a stripped down version of an OS in an attempt to increase boot speed.

The saved virtual machine image may be created by taking a snapshot of a newly installed OS. For example, the saved virtual machine image may be captured just following the first presentation of the graphical display during the first boot of the OS following installation. The saved virtual machine image, for execution under a hypervisor, may then be migrated to deployment computers where the user will see the saved state again upon booting into the instant-on environment. The instant-on system (which might also be referred to herein as a “rapid availability” system) may boot in approximately eight to ten second or less according to embodiments presented herein.

The following disclosure is also directed to technologies for providing an instant-on computing environment by restoring a saved state of a virtual machine into an instant-on hypervisor at boot time. The saved state virtual machine may also be loaded under a native OS using an OS-based hypervisor configured to execute under the primary OS. Thus, multiple environments may be provided simultaneously for executing the saved virtual machine image. Functionality is also disclosed for using the instant-on environment contemporaneously with the primary OS.

It should be appreciated that the above-described subject matter may also be implemented as a computing system, a computer-controlled apparatus, a computer process, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIGS. 1 and 3 are computer architecture diagrams showing aspects of several components provided herein;

FIGS. 2 and 4 are flow diagrams showing aspects of several embodiments disclosed herein; and

FIG. 5 is a computer architecture diagram showing aspects of one computing system upon which the software components described herein may be executed.

### DETAILED DESCRIPTION

The following detailed description is directed to technologies for an instant-on computing environment. In the following detailed description, references are made to the accompanying drawings that form a part hereof, and which are shown by way of exemplary embodiments and implementations. Note that although the subject matter presented herein has been described in conjunction with one or more particular embodiments and implementations, it is to be understood that the embodiments are not necessarily limited to the specific structure, configuration, or functionality described herein. Rather, the specific structure, configuration, and functionality described herein are disclosed as examples. Various modifications and changes may be made to the subject matter described herein without following the exemplary embodiments and applications illustrated and described, and without departing from the true spirit and scope of the embodiments disclosed herein.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following description, references are made to the accompanying drawings that form a part hereof, and which are shown by way of illustration specific embodiments or examples. Referring now to the drawings, in which like numerals represent like elements throughout the several figures, aspects of an instant-on computing system will be described.

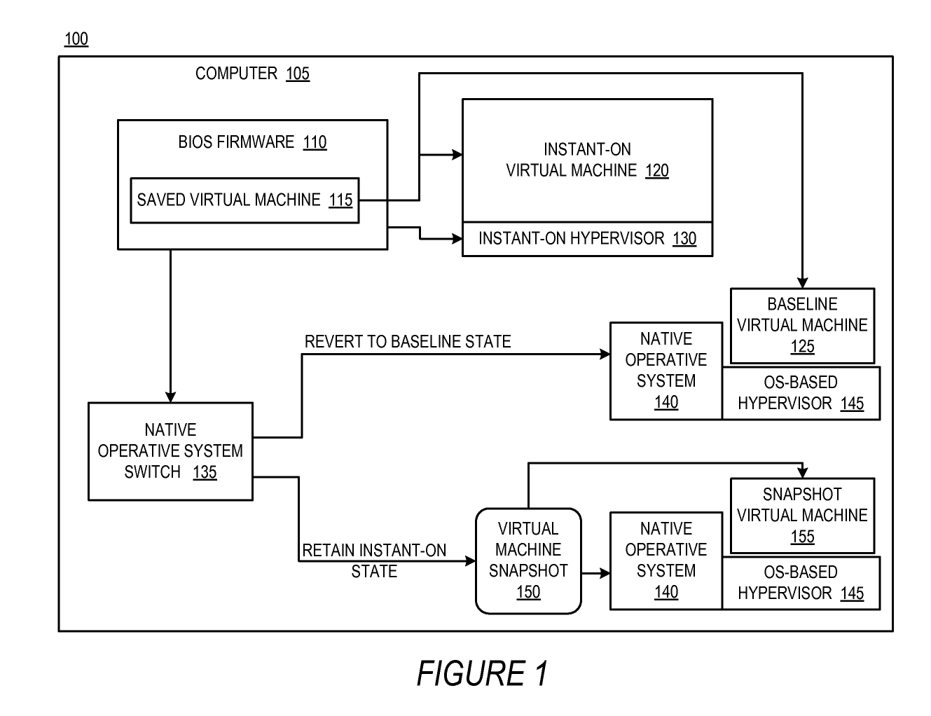

Turning now to FIG. 1, details will be provided regarding one illustrative operating environment for the embodiments presented herein. In particular, FIG. 1 is a block diagram 100 illustrating a computer 105 having a basic input/output system (“BIOS”) firmware 110 that supports a transition from an instant-on environment to a native OS environment according to one or more embodiments presented herein.

In the operating environment shown in FIG. 1, an instant-on hypervisor 130 may be launched by the firmware 110 at boot-time. The instant-on hypervisor 130 is a bare metal hypervisor that executes directly on the hardware of the computer 105 and that is launched by the firmware 110 at the time the computer 105 is powered on. A saved virtual machine image 115 stored in, or in conjunction with, the firmware 110 may be loaded as an instant-on virtual machine 120 in association with the instant-on hypervisor 130. The instant-on virtual machine 120 provides an instant-on environment for the computing system 105. The instant-on environment supports rapid booting for operation of the computing system 105 when compared to the time it typically takes to boot an operating system directly on the hardware of the computer 105.

The instant-on virtual machine 120 may be implemented using a thin operating system, a full operating system, an embedded operating system, a smart phone operating system, or any other operating environment suitable for execution on the instant-on hypervisor 130 executing on the computing system 105. The instant-on virtual machine 120 may support an instant-on operating environment having applications for performing various computer operations, such as World Wide Web (“Web”) browsing, electronic mail (“e-mail), instant messaging (“IM”), office productivity applications, word processing, spreadsheets, media players for audio and video files, and virtually any other type of application.

From the instant-on environment provided by the instant-on virtual machine 120, a user may trigger a native OS switch 135. Through the switch 135, the computer 105 is booted into the native OS 140. Upon switching to the native OS, an OS-based hypervisor 145 may be executed. The OS-based hypervisor 145 may be executed within the native OS 140.

According to one embodiment, a user of the computer 105 may select to retain the instant-on state of the instant-on environment provided by the instant-on virtual machine 120. To retain the instant-on state, a virtual machine snapshot 150 may be created of the instant-on virtual machine 120, thereby creating a snapshot virtual machine 155. After the native OS 140 is loaded and the OS-based hypervisor 145 is launched, the snapshot virtual machine 155 may be executed by the OS-based hypervisor 145. The snapshot virtual machine 155 may be loaded from the virtual machine snapshot 150 created prior to loading the native OS 140, thereby retaining the state within the snapshot as found in the instant-on environment prior to the native OS switch 135.

Alternately, at the time of the native OS switch 135, the user may opt to revert to a baseline state of the virtual machine. The baseline state may be similar, or identical, to that provided in the instant-on environment of the instant-on virtual machine 120. As such, the OS-based hypervisor 145 associated with the native OS 140 may mount the saved virtual machine image 115 from the firmware 110 as a baseline virtual machine 125.

It should be appreciate that the native OS 140 may comprise one of the WINDOWS family of operating systems from MICROSOFT CORPORATION, the OSX operating system from APPLE COMPUTER, INC., the LINUX operating system, or another type of operating system known in the art. Since the native OS 140 may execute directly on the underlying hardware, the native OS 140 may not require virtualization and thus may avoid modifications particular to a virtualization layer or particular hardware configurations. An advantage to operating the native OS 140 directly on the underlying hardware may be to realize the full speed and compatibility of the native OS 140. In contrast, an approach that operates an OS partially, or entirely, under a virtualization scheme may reduce performance or negatively impact robustness of the OS.

According to embodiments, both the instant-on hypervisor 130 and the OS-based hypervisor 145 may load configuration information stored in or in association with the firmware 110. Both the instant-on hypervisor 130 and the OS-based hypervisor 145 may be considered virtualization layers. As known in the art, virtualization may be utilized to implement a certain kind of virtual machine environment that provides a simulation of the underlying hardware.

According to embodiments, the computer 105 may comprise a standard notebook, laptop, or desktop computing system capable of executing the firmware 110, the instant-on hypervisor 130, and the native OS 140. It should be appreciated, however, that the computer 105 may comprise other types of computing devices, including a multimedia internet device (“MID”), a netbook, a smartphone, or other type of small form factor computing device. The firmware 110, may be BIOS, legacy BIOS, Extensible Firmware Interface (“EFI”) firmware, unified EFI firmware (“UEFI”), or another type of firmware.

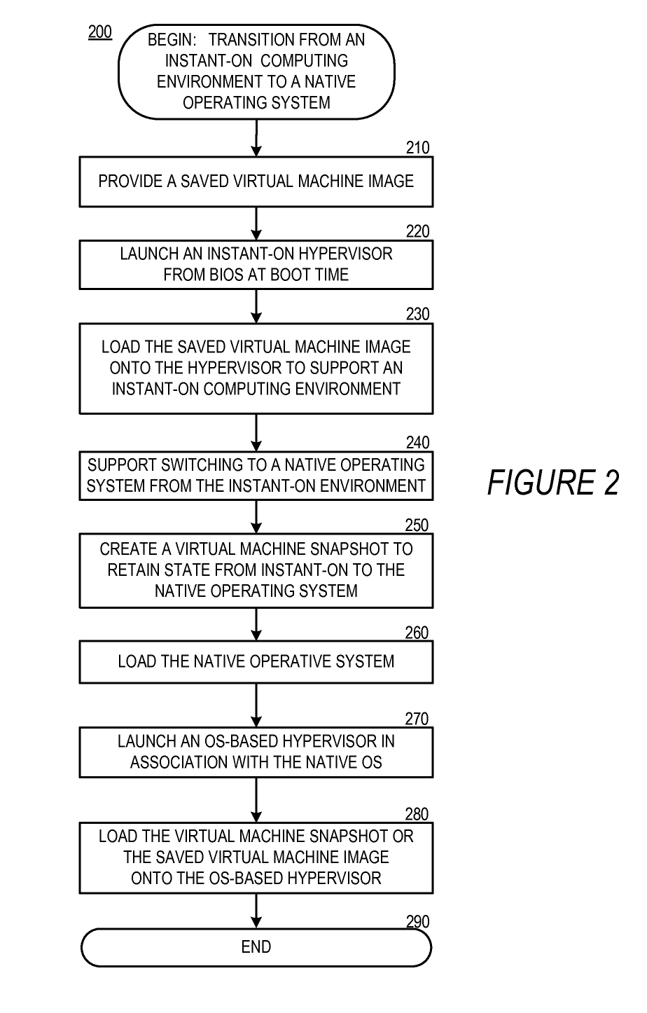

Referring now to FIG. 2, additional details will be provided regarding the embodiments presented herein for transitioning an instant-on computing environment. In particular, FIG. 2 is a flow diagram illustrating aspects of the operation of a process 200 presented herein for transitioning from an instant-on environment to a native operating system in the manner disclosed herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 200 begins at operation 210 where a saved virtual machine image 115 is provided in, or in association with, the firmware 110. As discussed above, the saved virtual machine image 115 may be a snapshot of a functional instance of an operating system. The operating system may be MICROSOFT WINDOWS, LINUX, UNIX, or any other operating system. The saved virtual machine image 115 may also include applications, modules, and other software for use in the instant-on environment.

At operation 220, the instant-on hypervisor 130 is launched from the firmware 110 at boot time. As discussed above, the instant-on hypervisor 130 may operate on top of, or in association with, a thin operating system, such as LINUX, a real-time operating system, an embedded operating system, a modified version of the LINUX or UNIX operating system, or any other operating system. The instant-on hypervisor 130 might also comprise a bare-metal hypervisor that operates directly upon the hardware of the computer 105.

At operation 230, the saved virtual machine image 115 provided at operation 210 may be loaded by the instant-on hypervisor 130 to support an instant-on operating environment. The routine 200 then proceeds to operation 240, where a switch to the native operating system 140 is triggered. Switching from executing the instant-on environment to the native operating system 140 may be initiated by a user, an application or module executing within the instant-on virtual machine 120, or in association with the firmware 110. The switch from the instant-on environment to the native OS 140 may also be initiated by a hardware switch, button, or hot key.

From operation 240, the routine 200 proceeds to operation 250 where a virtual machine snapshot may be created to retain state information from the instant-on environment once the native OS 140 is loaded. Creating the virtual machine snapshot 150 may be skipped if the user has selected to revert to a baseline state using the baseline virtual machine 125.

From operation 250, the routine 200 proceeds to operation 260, where the native OS 140 is loaded. Loading the native OS 140 may be identical, or similar, to booting the native OS on the direct hardware or bare metal of the underlying computing system 105. Once the native OS 140 has been loaded, the routine 200 proceeds to operation 270 where the OS-based hypervisor 145 may be launched within, or in association with, the native OS 140. As discussed above, the OS-based hypervisor 145 may be identical to or similar to the instant-on hypervisor 130. However, the OS-based hypervisor 145 may operate with, or in conjunction with, the native OS 140. In contrast, the instant-on hypervisor 130 may execute directly on the hardware or bare metal of the underlying computer hardware 105.

From operation 270, the routine 200 proceeds to operation 280, where the virtual machine snapshot 150 created prior to loading the native OS 140 may be mounted by the OS-based hypervisor 145. The loading of the virtual machine snapshot 150 may be performed in an instance where the user has selected to retain state from the instant-on environment. A snapshot virtual machine 155 may be mounted from the virtual machine snapshot 150 created prior to loading the native operating system 140.

Alternately, when the option to retain instant-on state has not been selected by the user, the baseline virtual machine 125 may be loaded from the saved virtual machine image 115. The baseline virtual machine 125 may be loaded by the OS-based hypervisor 145. The saved virtual machine 115 may be the same, or similar, virtual machine image stored in, or in conjunction with, the firmware 110 for use in the instant-on environment. From operation 280, the routine 200 proceeds to operation 290 where it ends.

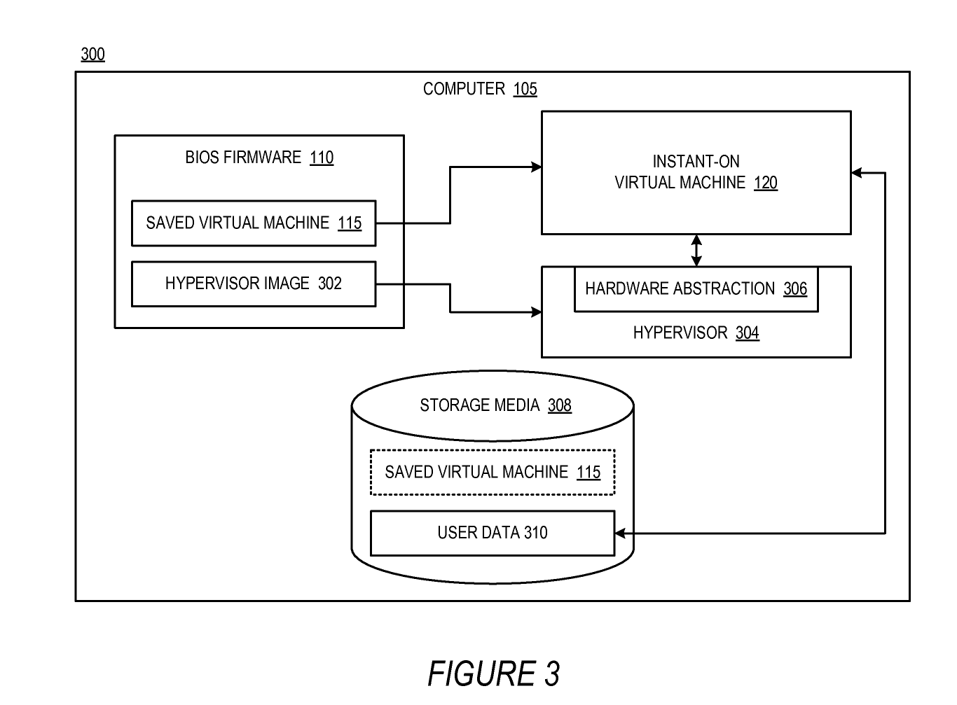

Turning now to FIG. 3, details will be provided regarding an embodiment presented herein for providing an instant-on computing environment by restoring a saved state of a virtual machine into an instant-on hypervisor at boot time. In particular, FIG. 3 is a block diagram 300 illustrating a computer 105 configured to support an instant-on virtual machine 120 through a firmware 110 according to one or more embodiments presented herein. The firmware 110 may be a BIOS for booting the computer 105 or another type of firmware. The firmware 110 can contain or be associated with a hypervisor image 302. The hypervisor may be considered a virtualization layer for supporting the execution of the instant-on virtual machine 120. As discussed above, virtualization may be utilized to implement a certain kind of virtual machine environment that provides a simulation of underlying computer hardware.

At startup of the computer 105, the firmware 110 can execute or launch the hypervisor image 302 as an operational hypervisor 304. The hypervisor 304 can support a hardware abstraction layer 306. The firmware 110 may also contain or be associated with a saved virtual machine 115. Upon launching the hypervisor 304, the saved virtual machine 115 may be mounted or accessed by the hypervisor 304 as the operating virtual machine 120.

The computer 105 may also comprise one or more storage media 308. According to embodiments, the saved virtual machine 115 may be stored in the storage media 308 or, alternatively, along with the firmware 110. The storage media 308 may be a hard drive, solid-state drive, non-volatile memory, magnetic storage, optical storage, or any other type of computer readable storage media. As used herein, the term computer readable storage media does not encompass transitory signals.

The computer 105 may comprise a standard notebook, laptop, or desktop computing system capable of executing a desktop operating system. It should be appreciated, however, that the computer 105 may comprise other types of computing devices, including a MID, a netbook, smartphone, or other type of small form factor computing device. The firmware 110 may be a BIOS, legacy BIOS, EFI firmware, UEFI firmware, or another type of firmware capable of executing on the computer 105.

Applications and other software may be associated with the virtual machine 120 shown in FIG. 3 as configured within the saved virtual machine image 115. User data 310 associated with application software or other modules associated with the virtual machine 120 may be stored as user data 310 on the computer readable storage media 308. When a saved virtual machine image 115 and user data 310 are both stored upon the storage media 308, the same or separate physical storage media 308 may be utilized.

According to embodiments, the firmware 110 may leverage a thin operating system such as a thin build of LINUX or UNIX to load the hypervisor image 302 as the operational hypervisor 304. The saved virtual machine 115 may be a snapshot of an operating system such as one of the WINDOWS family of operating systems from MICROSOFT CORPORATION, the OSX operating system from APPLE COMPUTER, INC., the LINUX operating system, or another type of computer operating system known in the art.

According to embodiments, rapid booting may be accomplished through the use of a stripped down operating system (i.e. an operating system that has had some non-essential components removed). However, the virtual machine 120 and corresponding saved virtual machine 115 may comprise a full featured operating system build such as MICROSOFT WINDOWS, LINUX, UNIX, a real time operating system, an embedded operating system, or otherwise. Even a full operating system instance may be loaded very rapidly using the saved state virtual machine to hypervisor technique disclosed herein. According to embodiments, the instant-on environment may be available in approximately eight seconds or less using instant-on technology supported by a hypervisor image 302 associated with the firmware 110 of the computer 105.

According to embodiments, firmware tools are used to generate the firmware 110. These tools may allow designers or original equipment manufacturers (“OEMs”) to build the firmware 110 with the appropriate embedded hypervisor image 302. Associated tools may be used to create the saved virtual machine image 115. The saved virtual machine image 115 may be associated with, or embedded into, the firmware 110. The saved virtual machine image 115 may also be stored in flash or other non-volatile memory. The saved virtual machine image 115 may also be saved on the storage media 308, such as a hard drive or a hard drive partition. Such a hard drive partition may be an invisible or hidden partition.

The instant-on, or rapid boot, technology disclosed herein may be used for safe mode booting, recovery, security, or any rapid booting of the computer 105. For example, an instant-on environment may be used to support an Internet client, a mobile information device, a smart phone, a media player, or any other possible application of the computer 105 where instant-on or rapid booting may be desirable.

The hardware abstraction layer 306 may provide a consistent set of device interfaces to the virtual machine 120. These device interfaces may support operation of the virtual machine 120 with respect to various underlying hardware associated with the computer 105. As such, the underlying hardware associated with the computer 105 may differ, change, or be updated without affecting device drivers and interfaces within the virtual machine 120.

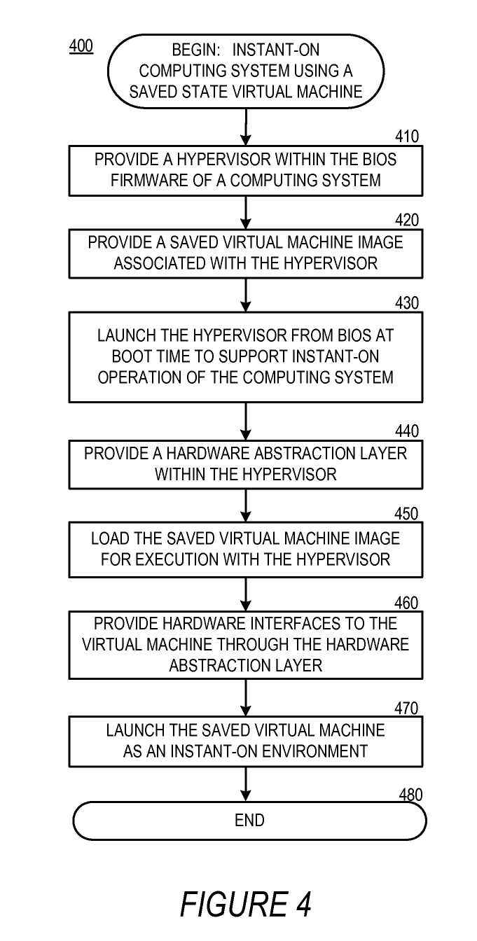

Referring now to FIG. 4, details will be provided regarding the embodiments presented herein for a saved state virtual machine supporting instant-on booting of a computing system. In particular, FIG. 4 is a flow diagram illustrating a process 200 performed by the computer 105 for supporting instant-on booting using virtual machine saved state in the manner discussed above with respect to FIG. 3.

The routine 400 begins at operation 410 where a hypervisor or hypervisor image 302 is provided within the firmware 110. As discussed above, the hypervisor may be a bare metal hypervisor designed to execute directly upon the underlying hardware of the computer 105. The hypervisor may be considered a virtualization layer for supporting the execution of virtual machine 120.

From operation 410, the routine 400 proceeds to operation 420, where the saved virtual machine image 115 associated with the hypervisor 304 is provided. The saved virtual machine image 115 may be created as a snapshot of a functioning operating system and may include applications and other software. The saved virtual machine image 115 may be stored in, or in association with, the firmware 110. The saved virtual machine image 115 may also be stored on a computer readable storage media 308, such as a hard drive, hard drive partition, or hard drive snapshot.

From operation 420, the routine 400 proceeds to operation 430, where the hypervisor image 302 may be launched from the firmware 110 to support instant-on operation as the operational hypervisor 304. At operation 440, a hardware abstraction layer 306 may be provided within the hypervisor 304. The hardware abstraction layer 306 may present a consistent set of device to the virtual machine 120. These devices may represent virtualized devices independent from actual hardware devices associated with the underlying hardware of the computer 105. For example, the hardware abstraction layer 306 may arbitrate between a standardized network interface driver exposed to the virtual machine 120 and any actual network interface hardware of the computer 105.

From operation 440, the routine 400 proceeds to operation 450, where the saved virtual machine 115 may be loaded for execution in association with the hypervisor 304. The loading of the saved virtual machine 302 as the operational virtual machine 120 can place the computer 105 into the operational state where the snapshot was taken to create the saved virtual machine 115. Such a snapshot may provide a consistent and clean instance of a functional operating system to be used at each boot of the computer 105. The operating system instance within the virtual machine 120 may be the same regardless of prior operation of the virtual machine 120 during previous operational sessions or boot sessions of the computer 105.

From operation 450, the routine 400 proceeds to operation 460, where hardware interfaces to the virtual machine may be provided through the hardware abstraction layer 306. The routine 400 then proceeds to operation 470, where the saved virtual machine image 115 may be launched as an instant-on environment. Since the saved virtual machine image 115 may already include the state reached at the end of booting, configuration, and setup of an operating system, the virtual machine 120 associated with the saved virtual machine image 115 may be operational as soon as it is loaded. This availability may occur in significantly less time compared to fully booting, initializing, and configuring the same operating system. From operation 470, the routine 400 proceeds to operation 480, where it ends.

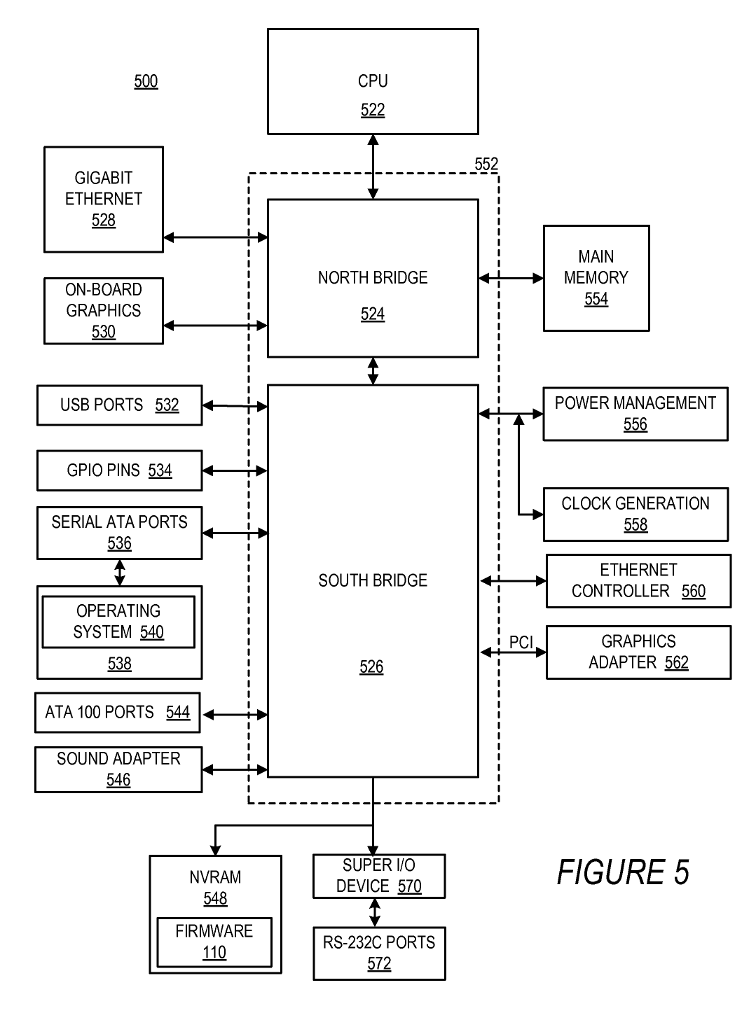

FIG. 5 shows an illustrative computer architecture for a computer 500 that may be utilized in the implementations described herein. The architecture for the computer 500 shown in FIG. 5 may be utilized to embody the computer 105 shown in FIGS. 1 and 3 and described above.

The computer 500 includes a baseboard, or “motherboard”, which is a printed circuit board to which a multitude of components or devices may be connected by way of a system bus or other electrical communication path. In one illustrative embodiment, a CPU 522 operates in conjunction with a chipset 552. The CPU 522 is a standard central processor that performs arithmetic and logical operations necessary for the operation of the computer. The computer 500 may include a multitude of CPUs 522.

The chipset 552 includes a north bridge 524 and a south bridge 526. The north bridge 524 provides an interface between the CPU 522 and the remainder of the computer 500. The north bridge 524 also provides an interface to a random access memory (“RAM”) used as the main memory 554 in the computer 500 and, possibly, to an on-board graphics adapter 530. The north bridge 524 may also include functionality for providing networking functionality through a gigabit Ethernet adapter 528. The gigabit Ethernet adapter 528 is capable of connecting the computer 500 to another computer via a network. Connections which may be made by the network adapter 528 may include LAN or WAN connections. LAN and WAN networking environments are commonplace in offices, enterprise-wide computer networks, intranets, and the Internet. The north bridge 524 is connected to the south bridge 526.

The south bridge 526 is responsible for controlling many of the input/output functions of the computer 500. In particular, the south bridge 526 may provide one or more universal serial bus (“USB”) ports 532, a sound adapter 546, an Ethernet controller 560, and one or more general purpose input/output (“GPIO”) pins 534. The south bridge 526 may also provide a bus for interfacing peripheral card devices such as a graphics adapter 562. In one embodiment, the bus comprises a peripheral component interconnect (“PCI”) bus, but other types of busses may be utilized.

The south bridge 526 is also operative to provide one or more interfaces for connecting mass storage devices to the computer 500. For instance, according to an embodiment, the south bridge 526 includes a serial advanced technology attachment (“SATA”) adapter for providing one or more serial ATA ports 536 and an ATA 100 adapter for providing one or more ATA 100 ports 544. The serial ATA ports 536 and the ATA 100 ports 544 may be, in turn, connected to one or more mass storage devices storing an operating system 540 and application programs, such as the SATA disk drive 538. As discussed above, an operating system 540 comprises a set of programs that control operations of a computer and allocation of resources. An application program is software that runs on top of the operating system software, or other runtime environment, and uses computer resources to perform application specific tasks desired by the user. As also discussed above, the computer 500 may be configured in the manner described above with reference to FIGS. 1 and 3 to provide functionality for instant-on booting of the computing system.

The mass storage devices connected to the south bridge 526, and their associated computer-readable storage media, provide non-volatile storage for the computer 500. Although the description of computer-readable storage media contained herein refers to a mass storage device, such as a hard disk or CD-ROM drive, it should be appreciated by those skilled in the art that computer-readable storage media can be any available storage media that can be accessed by the computer 500.

Computer-readable storage media includes volatile and non-volatile, removable and non-removable media implemented in any method or technology for storage of information such as computer-readable instructions, data structures, program modules or other data. For instance, computer-readable media includes, but is not limited to, RAM, ROM, EPROM, EEPROM, flash memory or other solid state memory technology, CD-ROM, DVD, HD-DVD, BLU-RAY, or other optical storage, magnetic cassettes, magnetic tape, magnetic disk storage or other magnetic storage devices, or any other medium which can be used to store the desired information and which can be accessed by the computer. As discussed above, the term computer readable storage media as utilized herein does not encompass transitory signals.

The computer readable storage media may include one or more program modules such as those associated with the firmware 110, the instant-on hypervisor 130, the native OS 140, the OS-based hypervisor 145, or any of the various virtual machine images. The program modules may include software instructions that, when loaded into the CPU 522 and executed, transform a general-purpose computing system into a special-purpose computing system customized to facilitate all, or part of, the instant-on computing environment transitioning techniques disclosed herein. As detailed throughout this description, the program modules may provide various tools or techniques by which the computer 500 may participate within the overall systems or operating environments using the components, logic flows, and/or data structures discussed herein.

A low pin count (“LPC”) interface may also be provided by the south bridge 526 for connecting a “Super I/O” device 570. The Super I/O device 570 is responsible for providing a number of input/output ports, including a keyboard port, a mouse port, a serial interface 572, a parallel port, and other types of input/output ports. The LPC interface may also connect a computer storage media such as a ROM or a flash memory such as a NVRAM 548 for storing the firmware 120 that includes program code containing the basic routines that help to start up the computer 500 and to transfer information between elements within the computer 500. As discussed above, a smartphone operating system, a virtualization layer, and other program code may also be stored in the NVRAM 548 in embodiments.

The computer 500 may be implemented as a conventional computer system, an embedded control computer, a laptop, or a server computer, a mobile device, a set-top box, a kiosk, a vehicular information system, a mobile telephone, a customized machine, or other hardware platform. The CPU 522 may be a general purpose processor, a processor core, a multiprocessor, a multi-core processor, a graphics processor, a digital signal processing (“DSP”) processor, a customized computing device implemented within an application specific integrated circuit (“ASIC”), a customized computing device implemented within a field programmable gate array (“FPGA”), a customized computing device implemented within any type of programmable logic, a state machine, a reconfigurable processor, any other processing unit, or any combination or multiplicity thereof.

The firmware 110 may comprise program modules for supporting instant-on operations using saved state virtual machines as disclosed herein. The storage media 308 and the storage drives 538 may comprise additional program modules for supporting instant-on operations using saved state virtual machines. The program modules may include software instructions that, when loaded into the CPU 522 and executed, transform a general-purpose computing system into a special-purpose computing system customized to facilitate all, or part of, the instant-on techniques disclosed herein. As detailed throughout this description, the program modules may provide various tools or techniques by which the computer 500 may participate within the overall systems or operating environments using the components, logic flows, and/or data structures discussed herein.

The CPU 522 may be constructed from any number of transistors or other circuit elements, which may individually or collectively assume any number of states. More specifically, the CPU 522 may operate as a state machine or finite-state machine. Such a machine may be transformed to a second machine, or specific machine by loading executable instructions contained within the program modules. These computer-executable instructions may transform the CPU 522 by specifying how the CPU 522 transitions between states, thereby transforming the transistors or other circuit elements constituting the CPU 522 from a first machine to a second machine, wherein the second machine may be specifically configured to support instant-on operations using saved state virtual machines. The states of either machine may also be transformed by receiving input from one or more user input devices, network interfaces 560, 528, other peripherals, other interfaces, or one or more users or other actors. Either machine may also transform states, or various physical characteristics of various output devices such as printers, speakers, video displays, or otherwise.

Encoding the program modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the semiconductor memory 554, 548 when the software is encoded therein. For example, the software may transform the state of transistors, capacitors, or other discrete circuit elements constituting the semiconductor memory.

As another example, the storage media may be implemented using magnetic or optical technology such as hard drives or optical drives. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

It should be appreciated that the computer 500 may comprise other types of computing devices, including hand-held computers, netbooks, MIDs, embedded computer systems, personal digital assistants, and other types of computing devices known to those skilled in the art. It is also contemplated that the computer 500 may not include all of the components shown in FIG. 5, may include other components that are not explicitly shown in FIG. 5, or may utilize an architecture completely different than that shown in FIG. 5.

Based on the foregoing, it should be appreciated that technologies for a saved state virtual machine supporting instant-on booting of a computing system are provided herein. It should also be appreciated that technologies for transitioning an instant-on computing environment to a native operating system computing environment are also provided herein.

Although the subject matter presented herein has been described in language specific to computer structural features, methodological and transformative acts, specific computing machinery, and computer readable media, it is to be understood that the disclosure presented herein is not necessarily limited to the specific features, acts, or media described herein. The subject matter described above is provided by way of illustration only and should not be construed as limiting. Various modifications and changes may be made to the subject matter described herein without following the example embodiments and applications illustrated and described, and without departing from the true spirit and scope of the disclosure presented herein.

What is claimed is:

1. A computer-implemented method for providing an instant-on computing environment, the method comprising performing computer-implemented operations for:
providing a saved virtual machine image;
executing an instant-on hypervisor at a boot time of a computer;
loading the saved virtual machine image into the instant-on hypervisor to thereby provide the instant-on computing environment;
receiving a request to switch from the instant-on computing environment to a native operating system; and
in response to the request, causing the native operating system to be executed by the computer, executing an operating system based hypervisor on the native operating system, and loading the saved virtual machine image in the operating system based hypervisor to thereby provide the instant-on computing environment in conjunction with the native operating system.

2. The computer-implemented method of claim 1, wherein the saved virtual machine image is stored in a non-volatile memory of the computer.

3. The computer-implemented method of claim 2, wherein the instant-on hypervisor is stored in the non-volatile memory of the computer.

4. The computer-implemented method of claim 3, wherein executing an instant-on hypervisor at a boot time of a computer comprises booting a thin operating system on the computer and executing the instant-on hypervisor on the thin operating system.

5. The computer-implemented method of claim 3, wherein the instant-on hypervisor comprise a bare metal hypervisor.

6. The computer-implemented method of claim 3, further comprising taking a virtual machine snapshot.

7. The computer-implemented method of claim 6, further comprising loading the virtual machine snapshot into the operating system based hypervisor.

8. The computer-implemented method of claim 7, wherein the snapshot is stored in the non-volatile memory of the computer.

9. The computer-implemented method of claim 8, wherein the instant-on computing environment comprises one or more application programs.

10. A computer-readable storage medium having computer-executable instructions stored thereupon which, when executed by a computer, cause the computer to:
provide a saved virtual machine image;
execute an instant-on hypervisor at a boot time of a computer;
load the saved virtual machine image into the instant-on hypervisor to thereby provide the instant-on computing environment;
receive a request to switch from the instant-on computing environment to a native operating system; and
in response to receiving the request, to cause the native operating system to be executed by the computer, to execute an operating system based hypervisor on the native operating system, and to load the saved virtual machine image in the operating system based hypervisor to thereby provide the instant-on computing environment in conjunction with the native operating system.

11. The computer-readable storage medium of claim 10, wherein executing an instant-on hypervisor at a boot time of a computer comprises booting a thin operating system on the computer and executing the instant-on hypervisor on the thin operating system.

12. The computer-readable storage medium of claim 10, wherein the instant-on hypervisor comprise a bare metal hypervisor.

13. The computer-readable storage medium of claim 12, having further computer readable instructions stored thereupon which, when executed by the computer, cause the computer to take and store a virtual machine snapshot.

14. The computer-readable storage medium of claim 13, having further computer readable instructions stored thereupon which, when executed by the computer, cause the computer to load the virtual machine snapshot into the operating system based hypervisor.

15. A computing system comprising:
a central processing unit (CPU); and
a non-volatile memory accessible by the CPU, the non-volatile memory storing a firmware, a saved virtual machine, and an instant-on hypervisor, and
wherein the firmware is configured when executed by the CPU to cause the instant-on hypervisor to be executed by the CPU at a boot time of a computing system, to cause the saved virtual machine image to be loaded into the executing instant-on hypervisor to thereby provide an instant-on computing environment, to receive a request to switch from the instant-on computing environment to a native operating system and, in response to receiving the request, to cause the native operating system to be executed by the computing system, to cause an operating system based hypervisor to be executed on the native operating system, and to cause the saved virtual machine image to be loaded into the operating system based hypervisor to thereby provide the instant-on computing environment in conjunction with execution of the native operating system.

16. The computing system of claim 15, wherein executing an instant-on hypervisor at a boot time of a computer comprises booting a thin operating system on the computing system and executing the instant-on hypervisor on the thin operating system.

17. The computing system of claim 16, wherein the instant-on hypervisor comprise a bare metal hypervisor.

18. The computing system of claim 17, wherein the firmware is further configured to create a virtual machine snapshot.

19. The computing system of claim 18, wherein the firmware is further configured to load the virtual machine snapshot into the operating system based hypervisor.

20. The computing system of claim 19, wherein the instant-on computing environment comprises one or more application programs.
